(19) United States
(12) Patent Application Publication
(10) Pub. No.: US 2004/0176265 A1
(43) Pub. Date: Sep. 9, 2004

(54) Novel use of cyclodextrin inclusion complexes

(76) Inventors: Alain Milius, Nice (FR); Gerard Trouve, Castres (FR); Jean-Pierre Boiteaux, Saix (FR); Tzvetana Bojinova, Toulouse (FR); Nancy De Viguerie, Toulouse (FR); Veronique Poinsot, Lacroix Falgarde (FR); Isabelle Rico Lattes, Auzielle (FR)

Correspondence Address: Air Liquide, Intellectual Property Department, Suite 1800, 2700 Post Oak Blvd, Houston, TX, 77056, US

(21) Appl. No.: 10/480,177

(22) PCT Filed: Jun. 4, 2002
(86) PCT No.: PCT/FR02/01876

(30) Foreign Application Priority Data
Jun. 8, 2001 (FR) 01/07499

(51) Int. Cl. C11D 1/00

(52) U.S. Cl. 510/470

(57) ABSTRACT

The invention concerns the use as surfactants of inclusion complexes in the form of powder or aqueous dispersion between a cyclodextrin and a fatty substance. The invention also concerns a method for preparing an emulsion using said inclusion complexes and the emulsions obtained using said method. The invention is applicable to cosmetic, pharmaceutical, food and industrial products.

A subject matter of the present invention is the use, as surfactants, of cyclodextrin-fatty substance inclusion complexes, in particular for the preparation of emulsions.

The invention finds application in particular in the cosmetic, pharmaceutical, food and industrial fields.

It is known that nonionic surfactants, which represent a significant part (approximately 40% in 1998) of world surfactant production, are virtually all obtained by the use of synthetic processes comprising a stage of condensation of ethylene oxide. For this reason, these compounds can include impurities, such as, for example, dioxane or ethylene oxide, which are generally regarded as toxic products harmful to the health.

For this reason, novel nonionic surfactants have been developed which comprise a hydrophilic part derived from sugar or from glycerol. Mention may be made, among these compounds, of alkylpolyglucosides, sorbitan esters, methyl glucose esters, sucrose esters, aldonic acid amides, polyglycerol ethers, polyglycerol esters, polyglycerol methyl glucose esters, lactitol esters, lactose esters, glucose esters, glucose ethers, sucrose ethers, alkylglucamines, or glycamine amides or glycamides.

However, although devoid of impurities originating from the condensation of ethylene oxide, these compounds are all obtained by chemical reactions using catalysts which are also capable of generating unidentified and possibly toxic byproducts.

Under these conditions, there exists a need, unsatisfied to date, to have available novel nonionic surfactants which are entirely devoid of impurities and which are capable of being satisfactorily obtained on an industrial scale.

It has been discovered, and it is this which constitutes the basis of the present invention, that some compounds obtained by inclusion of fatty substances in the cavity of a cyclodextrin, and known as “inclusion complexes”, exhibit noteworthy surfactant properties which make it possible to envisage their use as emulsifying agents or alternatively as foaming agents in various applications.

These inclusion complexes, characterized by a bond of non-covalent type between the hydrophilic cyclodextrin and the hydrophobic fatty substance, are obtained by the use of mild reactions not involving any chemical catalysts. They are therefore devoid of toxic byproducts.

In addition, by careful choice of the cyclodextrins and fatty substances constituting them, it is possible to adjust at will the surfactant properties, and in particular the hydrophilic/lipophilic balance, of these inclusion complexes and thus to have available a novel family of compounds covering all the properties of surfactants: hydrotropic, solubilizing, wetting, foaming, detergent and emulsifying.

It should be noted that there already exist surface-active compounds derived from cyclodextrins.

However, these known compounds, which are obtained by esterification of one or more hydroxyl functional groups of the cyclodextrin by a fatty acid, comprise a hydrophilic-hydrophobic bond of covalent type resulting from a conventional chemical synthesis with catalyst and solvent and therefore exhibit the same disadvantages as the surface-active compounds described above.

In addition, these compounds have few applications because of their limited stability toward hydrolysis.

It should also be noted that the literature describes a few examples of uses benefiting from the formation of inclusion complexes between cyclodextrins and fatty substances.

Thus it is that the formation of complexes between cyclodextrins and fatty substances has been turned to advantage in particular:

in extracting undesirable compounds, such as cholesterol (U.S. Pat. No. 4,880,573) or free fatty acids (U.S. Pat. No. 5,560,950), from various food oils;

in preparing or stabilizing emulsions for food use, such as mayonnaises, or alternatively industrial emulsions, such as cutting fluids (WO 94/01518).

In the latter case, it is the ability of cyclodextrins to form amphiphilic complexes by partial inclusion of the constituents of the fatty phase which it is desired to turn to advantage in obtaining an emulsion.

However, this method is empirical and offers no guarantee of success since it is known that cyclodextrins can result, under similar conditions of use, in the reverse result, namely breaking stable emulsions by complexing the fatty substances of these emulsions (WO 95/34363).

These known processes thus result in the best of cases in cyclodextrin-based emulsifiers:

the structure of which is uncertain since fatty phases of different natures are generally used in an emulsion and since it is not possible to predict which of these fatty phases will actually be included in the cyclodextrin;

the stoichiometry of which is unknown; and

the amount of which really formed is unknown since the preparation is carried out in situ.

The result of this is that these known processes do not make it possible to control the three essential parameters necessary to select an appropriate emulsifier for the preparation of a stable emulsion, namely its structure, its hydrophilic/lipophilic balance (HLB) and its concentration.

The document JP 58-58139 discloses a process for the preparation of oil-in-water emulsions essentially characterized in that it comprises:

the preparation of an emulsifying composition by dispersion of a cyclodextrin in glycerol or in an aqueous glycerol solution and then the addition of a surfactant which is soluble in the oil;

the addition to the mixture thus obtained of an oil, such as liquid paraffin or a silicone oil, thus forming a stable oil-in-glycerol emulsion; and

the addition of water to the emulsion thus obtained, thus forming an oil-in-water emulsion.

It is indicated in this prior document that trioleyl phosphate, aliphatic alcohols and fatty acids having from 8 to 20 carbon atoms can be used instead of the surfactant soluble in the oil in the above-mentioned first stage.

The process disclosed in this prior document is more satisfactory than the processes of the state of the art discussed previously, in particular in that it makes possible better control of the structure of the emulsifier.

However, this process still exhibits a great many disadvantages:

it does not make it possible to know the amount of emulsifier formed (it is not even known if it is formed) or its stoichiometry and consequently its HLB balance;

it is relatively complicated in that it comprises the intermediate preparation of a stable oil-in-glycerol emulsion;

it requires the use of large amounts of glycerol;

it requires a manufacturing operation limited to the amount necessary for the manufacture of the emulsion and is therefore not suited to use on an industrial scale.

It has been discovered, in an entirely unexpected way, that it is possible to prepare complexes based on cyclodextrin and on fatty substances which exhibit perfectly controlled surfactant properties and which are provided in a form suited to their use as surfactant, in particular as emulsifier or alternatively as foaming or wetting agent in various applications.

Thus, according to a first aspect, the present invention relates to the use as surfactants of inclusion complexes, in the form of a powder or in aqueous dispersion, between a cyclodextrin and a fatty substance.

The cyclodextrins capable of being used in the context of the present invention can be of various natures and will generally be chosen from α-, β- or γ-cyclodextrins, a mixture of the latter or alternatively cyclodextrins chemically modified by functionalization of the hydroxyl groups to give hydroxyethyl, hydroxypropyl, methyl, galactosyl, glycosyl or maltosyl functional groups.

The cyclodextrin constituting the inclusion complexes according to the invention will advantageously be chosen from:

a β-cyclodextrin, such as, for example, the product sold under the name Kleptose® by Roquette, Cavanax W7 by Wacker-Chemie GmbH or C. Cavitron 82900 by Cerestar;

a hydroxypropyl-β-cyclodextrin, such as, for example, the product sold under the name Cavasol W7 HP by Wacker-Chemie GmbH;

a methyl-β-cyclodextrin, sold under the tradename Cavasol W7M by Wacker-Chemie GmbH.

The fatty substances capable of being used in the context of the present invention will be chosen from fatty alcohols, fatty acids, fatty acid esters, mono-, di- and triglycerides, or their mixtures.

The fatty alcohols capable of being used in the context of the present invention will generally be saturated or unsaturated and linear or branched alcohols of natural or synthetic origin, such as, for example, alcohols originating from vegetable matter (coconut, palm kernel, palm), alcohols originating from animal matter (tallow) or Guerbet alcohols, the number of carbon atoms of which is between 8 and 36.

The fatty acids capable of being used in the context of the present invention will generally be saturated or unsaturated and linear or branched acids of natural or synthetic origin, the number of carbon atoms of which is between 8 and 36.

Mention will in particular be made, among the fatty acid esters capable of being used in the context of the present invention, of the methyl, ethyl and propyl esters.

Mention will in particular be made, among the triglycerides capable of being used in the context of the present invention, of vegetable oils, such as, for example, sunflower oil, rapeseed oil, corn oil, soybean oil or castor oil. Mention will be made, among the mono- and diglycerides, of the products of glycerolysis of vegetable oils.

The surfactants in accordance with the invention can be prepared in a way known per se and will advantageously be used after having been isolated, preferably in the solid form or in aqueous dispersion.

These compounds can be prepared from a solution or a suspension of cyclodextrin and of fatty substance.

The process for the preparation of the complexes in solution consists essentially:

in intimately mixing in solution at least one cyclodextrin and one fatty substance at a temperature and for a time sufficient to produce a homogeneous solution;

in precipitating the inclusion complex by controlled cooling of the homogeneous solution thus obtained.

In this process, water will generally be used as sole solvent but it may be necessary to add thereto a small amount of organic solvent to dissolve the fatty substance and to improve its solubilization in the aqueous phase.

Generally, the reaction mixture, composed of the cyclodextrin, fatty substance and above-mentioned solvent, will be heated and then subjected to vigorous stirring to result in a homogeneous solution.

The conditions necessary to produce a homogeneous solution (temperature of the reaction mixture, intensity and duration of the stirring) can be easily determined by a person skilled in the art.

Advantageously, the operation will be carried out at a temperature of between 40 and 80° C., preferably between 50 and 70° C., with vigorous stirring for a period of between 10 and 30 hours.

In this process, the complexing (that is to say the inclusion of the fatty substance in the cyclodextrin) is preferably carried out under standard pressure by controlled cooling of the homogeneous solution prepared beforehand, comprising a first phase during which the temperature is gradually lowered, for example to a value of the order of 4° C., and a second phase during which the reaction mixture is maintained at this low temperature for a period of time sufficient for the complex to crystallize, for example of the order of 10 to 30 hours.

The complex thus obtained can be isolated, for example by filtration, and can optionally be dried, ground, sieved and granulated for its subsequent use as surfactant in the solid form.

The solution preparation process is relatively lengthy and may require the use of an organic solvent.

For this reason, the surfactants used in the context of the present invention will preferably be prepared by a faster suspension process which avoids recourse to an organic solvent. This process consists essentially:

in adding the fatty substance to an aqueous suspension or dispersion of cyclodextrin, and

in heating the suspension or dispersion thus obtained at a temperature of the order of 30 to 70° C., preferably of 40 to 60° C., with stirring, for a period of time of between 1 and 8 hours, preferably between 1 and 3 hours.

The nature of the fatty substance and the nature of the cyclodextrin are capable in this case of influencing the viscosity of the suspension and, for this reason, the concentrations of cyclodextrin and of fatty substance will be adjusted to make it possible to obtain a homogeneous mixture between the cyclodextrin and the fatty substance.

The optimum conditions for obtaining an inclusion complex by the suspension process can be easily determined by a person skilled in the art.

The complex obtained can be isolated, for example by drying or lyophilization, and can optionally be dried, ground, sieved and granulated for its subsequent use as surfactant in the solid form.

Whatever the process of preparation chosen, the molar ratio of the cyclodextrin to the fatty substance in the reaction mixture which makes it possible to obtain the inclusion complexes which form the surfactants in accordance with the present invention will preferably be less than 1.

Under these conditions, it has been observed, in an entirely unexpected way, that the inclusion complexes obtained have excellent surfactant properties and, for this reason, are of great interest in the preparation of compositions, in particular wetting, foaming, detergent and emulsifying compositions.

In an entirely unexpected way, it has been discovered that the inclusion complexes formed with fatty alcohols exhibit surfactant properties and a stability which are markedly superior to those of the inclusion complexes formed with other fatty substances with the same hydrocarbonaceous chain length, such as, for example, fatty acids or fatty acid methyl esters.

In addition, in an entirely surprising way, it has been shown that the surfactant properties of the complexes of cyclodextrin and of fatty alcohols can be significantly improved by using, in their preparation, a stoichiometric excess of fatty alcohol.

It has been found that the complexes of cyclodextrin and of fatty alcohols, of fatty acids and of esters of fatty acids and of mono-, di- and triglycerides having 16 or more carbon atoms exhibit noteworthy emulsifying properties which allow them to be used in the preparation of emulsions, in particular in the cosmetic, pharmaceutical, agricultural or food fields.

Generally, these complexes will be used as emulsifier in an amount of between 1 and 25% by weight with respect to the total weight of the emulsion.

The emulsions prepared from these complexes will, in addition, preferably comprise:

from 5 to 75% by weight of an aqueous phase; and

from 20 to 90% by weight, preferably from 20 to 60% by weight, of a fatty or oily phase.

This fatty or oily phase can be composed of one or more oils chosen from oils of vegetable origin, modified vegetable oils, oils of natural origin, mineral oils, synthetic oils or fatty substances of vegetable, animal or synthetic origin.

These emulsions can also optionally comprise up to 10% by weight of a coemulsifier and up to 10% by weight of a stabilizing agent.

In their application as emulsifying surfactants, the complexes will be used according to the invention in the solid form or in the form of an aqueous dispersion.

The invention will be illustrated in more detail by the examples which follow, given solely by way of illustration.

In these examples:

the percentages are expressed by weight and the temperature is ambient temperature, unless otherwise indicated;

the NMR analyses (solvent: d₆-DMSO) were carried out on AC 200 Brucker spectrometers at 400 MHz for ¹H NMR and at 75 MHz or 100 MHz for ¹³C NMR;

the Mass Spectrometry (MS) analyses were carried out on an Autospec Micromass (England) spectrometer in the FAB, positive LSIMS ionization mode with Cs at 16 kV, matrix: glycerol/thioglycerol 1:1;

the InfraRed (IR) analyses were carried out on a Perkin-Elmer 1760 X FTIR spectrophotometer with a KBr beam splitter;

the differential scanning calorimetry (DSC) analyses were carried out under an inert atmosphere (N₂) on a Perkin-Elmer Pyris 1 DSC device;

the surface tension measurements were carried out on a Lauda TD1 tensiometer in combination with a thermostatically controlled bath and on a Kruss GmbH model DSA 10-Mk2 drop tensiometer;

the melting points were measured by differential scanning calorimetry.

### EXAMPLE 1

### Preparation of the Inclusion Complex Between β-cyclodextrin (β-CD) and dodecanoic acid (C₁₁H₂₃COOH)

A. By a Solution Process

1.416 g of β-CD, sold by Roquette under the name cyclodextrin Kleptose®, are dissolved at ambient temperature in 76.6 ml of distilled water by virtue of energy contributed ultrasonically for 15 minutes. The solution obtained is magnetically stirred, degassed with a stream of argon and then heated to 50° C. 7.7 ml of a solution comprising 250 mg of dodecanoic acid in acetone (this solution is obtained after gentle heating) are added to this solution. Stirring is maintained, at 50° C. or at a temperature ranging up to 70° C., until a homogeneous solution is obtained (mean duration: 2 days).

The reaction mixture thus prepared is cooled from 70° C. to 4° C. over 6 hours and is then maintained at 4° C. for 2 days (time necessary for the crystallization and for the separation by settling of the complex). The supernatant phase is removed and then the solid collected is dried (over CaCl₂) in a vacuum oven at ambient temperature.

1.204 g of a solid white product are thus obtained, which product is subsequently characterized by ¹H NMR and ¹³C NMR, MS-FAB, DSC, TLC, IR and melting point.

B. By a Suspension Process

A weight of 2.000 g of dodecanoic acid is ground in a mortar with 12.823 g of β-cyclodextrin. A volume of 20.0 ml of distilled water is added in order to obtain a suspension which is subsequently mechanically stirred (300 revolutions/min) and is heated at 50° C. for 5 hours. The reaction mixture is then allowed to slowly cool to ambient temperature (20 hours) and is dried by lyophilization. The product is recovered in the form of a white powder and is subsequently characterized by the abovementioned techniques.

### EXAMPLE 2

### Preparation of the Inclusion Complex Between β-cyclodextrin (β-CD) and octadecanoic acid (C₁₇H₃₅COOH)

The preparation is carried out in the same way as in example 1 using 0.997 g of β-CD and 250 mg of octadecanoic acid in 53.9 ml of distilled water and 41.4 ml of acetone. 1.053 g of white crystals were obtained and analyzed by the same methods as those mentioned in example 1.

NMR spectroscopy makes it possible to demonstrate the complex and its stoichiometry. The characterization is based on the variations in the chemical shifts of the protons of the host molecule: β-CD. The protons which are the most affected are the protons situated inside the cavity, that is to say the H-3 and H-5 protons. The chemical shifts of the protons of the β-CD and their variations in the complex which has 1:1 stoichiometry are given in the following table.

| | H1 | H2 | H3 | H4 | H5 | H6ab | OH2 | OH3 | OH6 |
|---|---|---|---|---|---|---|---|---|---|
| δ [β-CD] | 4.829 | 3.301 | 3.632 | 3.351 | 3.548 | 3.657 | 5.750 | 5.690 | 4.471 |
| δ [β-CD/C₁₇H₃₅COOH] | 4.846 | 3.326 | 3.669 | 3.369 | 3.590 | 3.691 | 5.527 | 5.525 | 4.248 |
| Δδ = δ_{CD} − δ_{complex} | −0.017 | −0.025 | −0.037 | −0.018 | −0.042 | −0.034 | +0.223 | +0.165 | +0.223 |

### EXAMPLE 3

### Preparation of the Inclusion Complex Between β-cyclodextrin (β-CD) and docosanoic acid (C₂₁H₄₃COOH) by a Solution Process

A suspension of 25 mg of docosanoic acid in 4.5 ml of distilled water is subjected to ultrasound at ambient temperature for 1 hour 30 minutes. 0.083 g of β-CD are added to the suspension. The reaction mixture is again subjected to ultrasound for 7 minutes and is then magnetically stirred, degassed under a stream of argon and heated at 70° C. for 4 days.

The reaction mixture thus obtained is cooled and the complex is isolated as described in example 1.

0.110 g of product is thus obtained in the form of a white solid which is analyzed by the techniques mentioned in example 1.

In this case, the analysis by mass spectrometry is carried out using 10% trichloroacetic acid as ionizing agent. This analysis made it possible to demonstrate a complex of 1:1 stoichiometry.

MH⁺[β-CD/C₂₁H₄₃COOH] m/z=1476

### EXAMPLE 4

### Preparation of the Inclusion Complex Between β-cyclodextrin (β-CD) and dodecanol (C₁₂H₂₅0H)

A. By a Solution Process

The preparation is carried out according to the process described in example 1, using 1.523 g of β-CD dissolved in 82.3 ml of distilled water and 250 mg of dodecanol in 8.2 ml of acetone.

0.952 g of product is thus obtained in the form of a white solid, which is analyzed by the techniques mentioned in example 1.

In this case, the analysis by mass spectrometry is carried out using 1 mg/ml NaI as ionizing agent. This analysis made it possible to demonstrate a complex of 1:1 stoichiometry.

MH⁺[β-CD/C₁₂H₂₅OH] m/z=1321

MNa⁺[β-CD/C₁₂H₂₅OH] m/z=1343

The demonstration of the complex by DSC (Differential Scanning Colorimetry) is based on the disappearance of the melting peak of a “guest” molecule. When it is complexed, the latter does not have the crystalline structure of a free guest molecule which allows it to adsorb energy. The melting point of the fatty chain disappears when all the alcohol is complexed. Three peaks are present in the spectrum. The first corresponds to uncomplexed dodecanol, while the other two are assigned to dehydration, either of the uncomplexed β-cyclodextrin or of the complex. A peak characteristic of the complex is not assigned.

The most advantageous peak is the first: its area, which is proportional to the amount of the free dodecanol, makes it possible to quantify the complexing.

The relationship (ΔH_{free GM}/ΔH_{pure GM})×100=% uncomplexed GM is used to calculate the percentage of the guest molecule which has remained uncomplexed.

| | | |
|---|---|---|
| β-Cyclodextrin(β-CD) | T = 157.5° C. | ΔH = 350 ± 40 J · g⁻¹ |
| Dodecanol (C₁₂H₂₅OH) | T_{f} = 26.2° C. | ΔH = 203 J/g |
| Complex (β-CD/C₁₂H₂₅OH) | T_{f} = 24.4° C. | ΔH = 8.2 J · g⁻¹ |
| | T_{g} = 138.4° C. | ΔCₚ = 1.5 J · g⁻¹ · ° C.⁻¹ |
| | T = 157.9° C. | ΔH = 8.7 J · g⁻¹ |

Thus, the amount, expressed as percentage by mass, of uncomplexed dodecanol is 4±0.8%. The complexing yield is therefore 50%.

B. By a Suspension Process

A suspension of 13.922 g of β-cyclodextrin in 20 ml of distilled water is prepared. This suspension is mechanically stirred (300 revolutions/min) for 15 minutes and is heated to 50° C. 2.005 g of dodecanol are added to this suspension. Stirring is maintained for an additional 1 hour and at a mean temperature of 50° C. It is subsequently slowly cooled to ambient temperature and then dried by lyophilization. 14.096 g of white powder are recovered. The yield of the complexing is 95%.

### EXAMPLE 5

### Preparation of the Inclusion Complex Between β-cyclodextrin (β-CD) and octadecanol (C₁₈C₃₇0H) by a Solution Process

A solution of 1.05 g of β-CD in 56.7 ml of distilled water is obtained after contributing energy ultrasonically for 10 minutes at ambient temperature.

The solution obtained is magnetically stirred, heated to 60° C. and degassed by a stream of argon. 250 mg of octadecanol in solution in 5.7 ml of acetone (this solution is obtained after gentle heating) are added to this solution. Stirring is maintained at this temperature for 2 days until the supernatant solid phase (fatty chain) has disappeared, which disappearance moreover required a supplementary addition of 2 ml of acetone.

The reaction mixture thus obtained is slowly cooled from 60 to 4° C. and is then maintained at this temperature for 4 days (time necessary for the crystallization and for the separation by settling).

The supernatant phase is removed and the solid phase recovered is dried under vacuum at ambient temperature. 0.542 g of a white solid is thus obtained, which solid is subsequently characterized by the methods mentioned in example 1.

### EXAMPLE 6

### Preparation of the Inclusion Complex Between hydroxypropyl-β-cyclodextrin (HP-β-CD) and octadecanoic acid (C₁₇H₃₅COOH) by a Solution Process

1.85 g of HP-β-CD, sold by Roquette under the name of LAB 1456, are dissolved at ambient temperature in 3.1 ml of distilled water. A solution of 250 mg of octadecanoic acid in 2 ml of absolute ethanol is added. The reaction mixture is magnetically stirred, degassed under a stream of argon and heated at 60° C. for 2 days.

The mixture, which assumes the appearance of a gel, is subsequently allowed to slowly cool to 4° C. and this temperature is maintained for 3 days. The gel is dried under vacuum at ambient temperature for 8 hours. 2.088 g of product are thus obtained in the form of a white solid, which solid is analyzed by the methods mentioned in example 1.

### EXAMPLE 7

### Preparation of the Inclusion Complex Between hydroxypropyl-β-cyclodextrin (HP-β-CD) and dodecanol (C₁₂C₂₅OH) by a Solution Process

The preparation is carried out according to the process described in example 6, using 2.83 g of HP-β-CD in 4.7 ml of distilled water and 250 mg of dodecanol in 4.0 ml of absolute ethanol.

2.426 g of a white solid are thus obtained, which solid is analyzed using the methods mentioned in example 1.

The demonstration of the complex was carried out by DSC. Several peaks are present in the spectrum between 50 and 120° C. Pure HP-β-CD dehydrates at 157° C. and decomposes above 300° C. On the one hand, the absence of the peak corresponding to the melting of dodecan-1-ol and, on the other hand, the shift toward high temperatures of the T_{g} of HP-β-CD prove the quantitative formation of the complex. This is because an increase in the T_{g} reflects a stiffening of the compound which, in the present case, is due to inclusion of the guest molecule in the cavity of the cyclodextrin.

| | | |
|---|---|---|
| Hydroxypropyl -β- | T_{g} = 99.0° C. | ΔCₚ = 7.9 g⁻¹ · ° C.⁻¹ |
| cyclodextrin (HP-β-CD) | | |
| Dodecanol (C₁₂H₂₅OH) | T_{f} = 26.2° C. | ΔH = 203 J · g⁻¹ |
| Complex | T_{f} = 55° C. | ΔH = 2.2 J · g⁻¹ |
| (HP-β-CD.C₁₂H₂₅OH) | T_{f} = 59.8° C. | ΔH = 3.7 J · g⁻¹ |
| | T_{g} = 116.4° C. | ΔCₚ = 4.0 J · g⁻¹ · ° C.⁻¹ |

### EXAMPLE 8

### Preparation of the Inclusion Complex Between methyl-β-cyclodextrin (Me-β-CD) and dodecanol (C₁₂H₂₅OH) by a Solution Process

7.030 g of methyl-β-CD, sold by Wacker-Chemie under the name Cavasol® W7 M, are dissolved at ambient temperature in 5 ml of distilled water by virtue of an energy ratio ultrasonically for 20 minutes. The solution obtained is magnetically stirred, degassed by a stream of argon and then heated to 70° C. 1 g of dodecanol, in solution in 2.0 ml of absolute ethanol, is added to this solution. The reaction mixture obtained is maintained at 70° C. until a clear solution is obtained (3 days). It is subsequently cooled to ambient temperature over 3 days and then maintained at +4° C. (temperature at which the reaction mixture assumes the appearance of a gel) for 15 days. The gel obtained, dried under vacuum at ambient temperature for 8 hours, makes it possible to obtain the complex in the form of a white powder which is analyzed by the methods mentioned in example 1.

### EXAMPLE 9

### Preparation of the Inclusion Complex Between β-cyclodextrin (β-CD) and hexadecanol (C₁₆H₃₃OH) by a Solution Process

This complex is prepared under the conditions of example 5, octodecanol being replaced by hexadecanol.

### EXAMPLE 10

### Preparation of the Inclusion Complex Between β-cyclodextrin (β-CD) and methyl dodecanoate by a Suspension Process

A suspension of 12.200 g of β-cyclodextrin in 17.4 ml of distilled water is prepared and then mechanically stirred (300 revolutions/min) for 15 minutes at a temperature of 50° C. 2.016 g of methyl dodecanoate are added to this suspension. Stirring is maintained for an additional 3 hours at a mean temperature of 55° C. The reaction mixture is subsequently slowly cooled to ambient temperature and then dried by lyophilization. 12.385 g of product in the form of a white powder are recovered. Characterization is carried out by ¹H NMR in D₂O.

| | H1 | H2 | H3 | H4 | H6ab | H5 |
|---|---|---|---|---|---|---|
| δ [β-CD] | 5.081 | 3.652 | 3.975 | 3.594 | 3.888 | 3.864 |
| δ [β-CD.C₁₁H₂₃COOCH₃] | 5.065 | 3.635 | 3.952 | 3.582 | 3.866 | 3.837 |
| Δδ = δ_{CD} − δ_{complex} | 0.016 | 0.017 | 0.023 | 0.012 | 0.022 | 0.027 |

The variations in the chemical shifts for all the protons of the host, but in particular for H3 and H5 (situated inside the cavity of the cyclodextrin), allow it to be supposed that the complex has been formed.

Furthermore, the presence of the peaks corresponding to the guest molecule, which is initially insoluble in the water, also proves that this molecule is complexed.

Demonstration of the Surfactant Effect by Measurement Of the Surface Tensions of Aqueous Solutions of the Complexes of Examples 1, 4, 6, 7, 8 and 9

| | | | Surface tension |
|---|---|---|---|
| | | Concentration | mN · m⁻¹ |
| | Inclusion complex | mol · l⁻¹ | at 35° C. |
| Example 1 | [β-CD.C₁₁H₂₃COOH] | 2.7 × 10⁻³ | 42.4 |
| Example 4 | [β-CD.C₁₂H₂₅OH] | 2.0 × 10⁻³ | 30.3 |
| Example 6 | [HP-β-CD.C₁₇H₃₅COOH] | 1.4 × 10⁻³ | 56.1 |
| Example 7 | [HP-β-CD.C₁₂H₂₅OH] | 1.4 × 10⁻³ | 55.2 |
| Example 8 | [Me-β-CD.C₁₂H₂₅OH] | 2.5 × 10⁻³ | 29.7* |
| Example 9 | [β-CD.C₁₆H₃₃OH] | 1.9 × 10⁻³ | 46.1 |

*The surface tension of this complex is measured at 25° C.

The inclusion complexes are all powerful surfactants since they lower the surface tension of pure water from 72.0 mN.m⁻¹ to values of between 29.7 and 56.1 mN.m⁻¹.

Demonstration of the Superiority of the Complexes Obtained with Fatty Alcohols

A. Surfactant Properties

The surfactant properties are determined by measuring the surface tension of aqueous solutions of complexes obtained from fatty alcohols and of complexes obtained from fatty acids or from fatty acid ester where the fatty acid has the same chain length.

| | | | | | Surface |
|---|---|---|---|---|---|
| | | | Cyclodextrin/ | | tension |
| | Fatty | | fatty substance | Concentration | at 20° C. |
| | substance | Cyclodextrin | stoichiometry | mol · l⁻¹ | mN · m⁻¹ |
| Example 4 | Dodecanol | β-CD | 1/1 | 1.5 × 10⁻³ | 34.9 |
| Example 8 | Dodecanol | Me-β-CD | 1/1 | 1.5 × 10⁻³ | 34.4 |
| Example 7 | Dodecanol | HP-β-CD | 1/1 | 1.5 × 10⁻³ | 42.8 |
| Example 1 | Dodecanoic | β-CD | 1/1 | 2.0 × 10⁻³ | 51.8 |
| | acid | | | | |
| Example 10 | Methyl | β-CD | 1/1 | 1.5 × 10⁻³ | 55.3 |
| | dodecanoate | | | | |

B—Stability

The stability of the complexes is determined by measuring the surface tension of aqueous solutions of complexes after storing for 10 days at 20° C.:

| | | | | | Surface |
|---|---|---|---|---|---|
| | | | | Surface | tension at |
| | | | | tension at | 20° C. after |
| | Fatty | | Concentration | 20° C. | 10 days |
| | substance | Cyclodextrin | mol · l⁻¹ | mN · m⁻¹ | mN · m⁻¹ |
| Example 4 | Dodecanol | β-CD | 1.5 × 10⁻³ | 34.9 | 39.0 |
| Example 8 | Dodecanol | Me-β-CD | 1.5 × 10⁻³ | 34.4 | 38.0 |
| Example 7 | Dodecanol | HP-β-CD | 1.5 × 10⁻³ | 42.8 | 56.3 |
| Example 1 | Dodecanoic acid | β-CD | 2.0 × 10⁻³ | 51.8 | 61.6 |

It is clear on reading the preceding tables that:

the complexes of fatty alcohols are much more surface-active than the complexes of fatty acids or of fatty acid ester;

the complexes obtained from fatty alcohols are much more stable than those obtained from fatty acids and the complexes obtained with β-CD and Me-β-CD are more stable than those obtained with HP-β-CD.

Demonstration of the Effect of the cyclodextrin/fatty alcohol Stoichiometric Ratio on the Surfactant Properties

It has been discovered, in an entirely surprising way, that the surfactant properties are significantly improved on using a stoichiometric excess of fatty alcohols for the preparation of the complexes.

This aspect of the invention is demonstrated by the following example:

### EXAMPLE 11

### Preparation of the Inclusion Complex Between β-cyclodextrin (β-CD) and dodecanol in a Stoichiometric Ratio of 1/2

A suspension of 13.939 g of β-cyclodextrin in 20.0 ml of distilled water is prepared. This suspension is mechanically stirred (300 revolutions/min) for 15 minutes and is heated to 50° C. using a sand bath. 4.005 g of dodecan-1-ol are added to this suspension. The reaction mixture is kept stirred for an additional 1 hour at a mean temperature of 50° C. It is subsequently slowly cooled to ambient temperature and is then dried by lyophilization. A white powder is obtained which is characterized by ¹H NMR and DSC. The amount of uncomplexed dodecan-1-ol is 0%.

The surfactant properties are determined by measuring the surface tension of aqueous solution of complexes.

| | | | | | Surface |
|---|---|---|---|---|---|
| | | | Cyclodextrin/fatty | | tension |
| | Fatty | | substance | Concentration | at 20° C. |
| | substance | Cyclodextrin | stoichiometry | mol · l⁻¹ | mN · m⁻¹ |
| Example 4 | Dodecanol | β-CD | 1/1 | 1.5 × 10⁻³ | 34.9 |
| Example 11 | Dodecanol | β-CD | 1/2 | 1.5 × 10⁻³ | 24.5 |

It is clear that the complexes obtained from fatty alcohols exhibit increased surfactant properties since the fatty alcohol is in stoichiometric excess.

What is claimed is:

1. Use as surfactants of inclusion complexes, in the form of a powder or in aqueous dispersion, between a cyclodextrin and a fatty substance.

2. The use as claimed in claim 1, characterized in that the molar ratio of the cyclodextrin to the fatty substance in the abovementioned complex is less than or equal to 1.

3. The use as claimed in claim 1 or 2, characterized in that the abovementioned cyclodextrin is chosen from a β-cyclodextrin, a hydroxypropyl-β-cyclodextrin or a methyl-β-cyclodextrin.

4. The use as claimed in claim 1, 2 or 3, characterized in that the abovementioned fatty substance is a fatty alcohol chosen from saturated or unsaturated and linear or branched alcohols of natural origin or of synthetic origin, the number of carbon atoms of which is between 8 and 36.

5. The use as claimed in claim 4, characterized in that the molar ratio of the cyclodextrin to the fatty alcohol is less than 0.75.

6. The use as claimed in claim 1, 2 or 3, characterized in that the abovementioned fatty substance is a fatty acid chosen from saturated or unsaturated and linear or branched acids of natural or synthetic origin, the number of carbon atoms of which is between 8 and 36.

7. The use as claimed in claim 1, 2 or 3, characterized in that the fatty substance is a fatty acid ester.

8. The use as claimed in claim 1, 2 or 3, characterized in that the fatty substance is a tri-, di- or monoglyceride.

9. The use as claimed in any one of claims 1 to 8, characterized in that the abovementioned complex is obtained by the use of a process consisting essentially:
in intimately mixing in solution at least one cyclodextrin and one fatty substance, in a molar ratio of less than or equal to 1, at a temperature and for a time sufficient to produce a homogeneous solution;
in precipitating an inclusion complex by controlled cooling of the homogeneous solution thus obtained.

10. The use as claimed in any one of claims 1 to 8, characterized in that the abovementioned complex is obtained by the use of a process consisting essentially:
in adding the fatty substance to an aqueous suspension or dispersion of cyclodextrin; and
in heating the suspension or dispersion thus obtained at a temperature of the order of 30 to 70° C., preferably of 40 to 60° C., with stirring, for a period of time of between 1 and 8 hours, preferably between 1 and 3 hours.

11. The use as claimed in claim 9 or 10, characterized in that the abovementioned inclusion complex is isolated, for example by filtration, by drying or lyophilization, and is optionally dried, ground, sieved and granulated for its subsequent use in the solid form.

12. A process for the preparation of an emulsion, characterized in that it comprises the preparation of a cyclodextrin/fatty substance inclusion complex by the use of a process as claimed in claim 9 or 10, its dispersion in water and then the addition of a fatty phase with stirring.

13. A process for the preparation of an emulsion, characterized in that it comprises the preparation of a cyclodextrin/fatty substance inclusion complex by the use of a process as claimed in claim 9 or 10, its dispersion in a fatty phase and then the addition of water with stirring.

14. An emulsion, characterized in that it is obtained by the use of the process as claimed in either of claims 12 and 13 and in that it comprises:
from 1 to 25% by weight of at least one inclusion complex as defined in any one of claims 1 to 7 or obtained by the use of the process as claimed in any one of claims 8 to 10;
from 5 to 75% by weight of water; and
from 20 to 90% by weight of a fatty or oily phase.
